(19) United States
(12) Patent Application Publication
(10) Pub. No.: US 2025/0150652 A1
(43) Pub. Date: May 8, 2025

(54) MEDIA PLAYER SYSTEMS AND METHODS

(71) Applicant: Penthera Partners, Inc., New York, NY (US)

(72) Inventor: Joshua PRESSNELL, Spring Valley, OH (US)

(73) Assignee: Penthera Partners, Inc., New York, NY (US)

(21) Appl. No.: 18/760,426

(22) Filed: Jul. 1, 2024

Related U.S. Application Data
(60) Provisional application No. 63/547,102, filed on Nov. 2, 2023.

(51) Int. Cl. H04N 21/234; H04L 43/0811; H04N 21/458

(52) U.S. Cl. CPC H04N 21/23424; H04L 43/0811; H04N 21/458

(57) ABSTRACT

A process for playing media content from a local storage of a player device according to an embodiment. The process includes storing the media content on the local storage unit of the player device. The process also includes, after storing the media content, detecting a request to play the media content. The process also includes Process, after detecting the request to play the media content: performing a process for obtaining from a remote server a set of ad URLs and initiating playing the media content from the local storage unit.

### CROSS-REFERENCE TO RELATED APPLICATIONS

This application claims the benefit of U.S. provisional patent application No. 63/547,102, filed on 2023 Nov. 2, which is incorporated by this reference.

### TECHNICAL FIELD

Disclosed are embodiments related to media (e.g., video and/or audio) player systems and methods.

### BACKGROUND

Technology for streaming media content (e.g., video content and/or audio content) to a user is well established. Most streaming technologies, including Hypertext Transfer Protocol (HTTP) Live Streaming (HLS), a technology developed by Apple, Inc., and MPEG-Dynamic Adaptive Streaming over HTTP (DASH), work by dividing a media item (e.g., a 30 minute episode of a TV show) into many segments (e.g., 300 six-second segments) and providing to the player a segment manifest (or “manifest” for short) (e.g., an HLS playlist or an MPEG-DASH Media Presentation Description (MPD) or other information element that contains segment locator information) that enables the player to send to a remote server a request for each segment. Thus, for example, when a user wants to consume (e.g., watch and/or listen to) a particular media item, the user's media player may make a request to a server for a particular manifest for the media item (e.g., an HLS manifest or MPD), and, then, after obtaining the requested manifest, serially request the segments identified in the manifest (e.g., for each segment of the media item, the manifest may contain a Uniform Resource Locator (URL) that identifies the filename of the file that stores the segment and the location of the file on the Internet and/or segment template information that enables the player to determine the filenames and file locations).

After a player requests a manifest and before the manifest is provided to player, a process may select media to be inserted (e.g., a set of one or more ads) for an identified break (e.g., using an HLS playlist, the location of the break and its duration can be specified using the #EXT-X-CUE-OUT and #EXT-X-CUE-IN tags) and then insert into the manifest at the break position information for identifying segments of the selected media to be inserted (e.g., a set of ad segment URLs). In this way, selected media can be inserted into a media item at a predefined break.

For example, Table 1A below illustrates an example HLS playlist as it exists on the playlist server and Table 1B below illustrates a modified version of the HLS playlist shown in Table 1A which is provided to the player. A comparison of the two tables shows that five segment URLs have been inserted into the playlist.

TABLE 1A

#EXTM3U
#EXT-X-PLAYLIST-TYPE:VOD
#EXT-X-TARGETDURATION:6
#EXT-X-MEDIA-SEQUENCE:0
#EXTINF:6.0
http://cdn.com/vid-seg1.ts
#EXTINF:6.0
http://cdn.com/vid-seg2.ts
#EXT-X-CUE-OUT: 30.00
#EXT-X-CUE-IN:
#EXTINF:6.0
http://cdn.com/vid-seg3.ts

TABLE 1B

#EXTM3U
#EXT-X-PLAYLIST-TYPE:VOD
#EXT-X-TARGETDURATION:6
#EXT-X-MEDIA-SEQUENCE:0
#EXTINF:6.0
http://cdn.com/vid-seg1.ts
#EXTINF:6.0
http://cdn.com/vid-seg2.ts
#EXT-X-DISCONTINUITY
#EXTINF:6.0
http://adserver.com/Ad-seg1.ts
#EXTINF:6.0
http://adserver.com/Ad-seg2.ts
#EXTINF:6.0
http://adserver.com/Ad-seg3.ts
#EXTINF:6.0
http://adserver.com/Ad-seg4.ts
#EXTINF:6.0
http://adserver.com/Ad-seg5.ts
#EXT-X-DISCONTINUITY
#EXTINF:6.0
http://cdn.com/vid-seg3.ts

As another example, Table 2A below illustrates an example MPEG-DASH MPD as it exists on the manifest server and Table 2B below illustrates a modified version of the manifest shown in Table 2A, which is provided to the player. A comparison of tables 2A and 2B shows that a period element corresponding to a break and containing five ad segment URLs has been inserted into the manifest between a first period element containing a first subset of the segment URLs from the period element in the original manifest and a third period containing a second subset of the segment URLs from the period element in the original manifest.

```
TABLE 2A
<MPD ...>
<Period...>
  <AdaptationSet mimeType=″video/mp4″ ...>
    <Representation id=”rep1” bandwidth=″10392000″ ...>
      <SegmentList ...>
        <SegmentURL media=″http://cdn.com/vid-rep1-seg1.mp4″/>
        <SegmentURL media=″http://cdn.com/vid-rep1-seg2.mp4″/>
        <SegmentURL media=″http://cdn.com/vid-rep1-seg3.mp4″/>
        <SegmentURL media=″http://cdn.com/vid-rep1-seg4.mp4″/>
        <SegmentURL media=″http://cdn.com/vid-rep1-seg5.mp4″/>
        <SegmentURL media=″http://cdn.com/vid-rep1-seg6.mp4″/>
        <SegmentURL media=″http://cdn.com/vid-rep1-seg7.mp4″/>
        <SegmentURL media=″http://cdn.com/vid-rep1-seg8.mp4″/>
        <SegmentURL media=″http://cdn.com/vid-rep1-seg9.mp4″/>
        <SegmentURL media=″http://cdn.com/vid-rep1-seg10.mp4″/>
        <SegmentURL media=″http://cdn.com/vid-rep1-seg11.mp4″/>
        <Initialization sourceURL=″http://cdn.com/init1.mp4″/>
      </SegmentList>
    </Representation>
  </AdaptationSet>
</Period>
```

TABLE 2B

```
<MPD ...>
<Period id=”1” ...>
  <AdaptationSet mimeType=″video/mp4″ ...>
    <Representation bandwidth=″10392000″ ...>
      <SegmentList ...>
        <SegmentURL media=″http://cdn.com/vid-rep1-seg1.mp4″/>
        <SegmentURL media=″http://cdn.com/vid-rep1-seg2.mp4″/>
        <SegmentURL media=″http://cdn.com/vid-rep1-seg3.mp4″/>
        <SegmentURL media=″http://cdn.com/vid-rep1-seg4.mp4″/>
        <SegmentURL media=″http://cdn.com/vid-rep1-seg5.mp4″/>
        <SegmentURL media=″http://cdn.com/vid-rep1-seg6.mp4″/>
        <SegmentURL media=″http://cdn.com/vid-rep1-seg7.mp4″/>
        <Initialization sourceURL=″http://cdn.com/init1.mp4″/>
      </SegmentList>
    </Representation>
  </AdaptationSet>
</Period>
<Period id=”ad_break_1”...> /*This period is for the break **/
  <AdaptationSet mimeType=″video/mp4″ ...>
    <Representation bandwidth=″10392000″ ...>
      <SegmentList ...>
        <SegmentURL media=″http://adserver.com/Ad-rep1-seg1.mp4″/>
        <SegmentURL media=″http://adserver.com/Ad-rep1-seg2.mp4″/>
        <SegmentURL media=″http://adserver.com/Ad-rep1-seg3.mp4″/>
        <SegmentURL media=″http://adserver.com/Ad-rep1-seg4.mp4″/>
        <SegmentURL media=″http://adserver.com/Ad-rep1-seg5.mp4″/>
        <Initialization sourceURL=″http://adserver.com/init.mp4″/>
      </SegmentList>
    </Representation>
  </AdaptationSet>
</Period>
<Period id=”2”...>
  <AdaptationSet mimeType=″video/mp4″ ...>
    <Representation bandwidth=″10392000″ ...>
      <SegmentList ...>
        <SegmentURL media=″http://cdn.com/vid-rep1-seg8.mp4″/>
        <SegmentURL media=″http://cdn.com/vid-rep1-seg9.mp4″/>
        <SegmentURL media=″http://cdn.com/vid-rep1-seg10.mp4″/>
        <SegmentURL media=″http://cdn.com/vid-rep1-seg11.mp4″/>
        <Initialization sourceURL=″http://cdn.com/init1.mp4″/>
      </SegmentList>
    </Representation>
  </AdaptationSet>
</Period>
</mpd>
```

### SUMMARY

Certain challenges presently exist. For instance, the user's media player device may not have sufficient network access at the time the user wants to consume advertisement supported media content (e.g., watch an episode of a television show or watch a movie). A solution to this problem is for the content provider (e.g., a streaming service provider) to make available for download the media content that the user wants to consume. When the user downloads the media content from the content provider to his/her device a set of ads may also be downloaded to the device. The downloaded media content and the set of ads may be stored on the device's long term local storage (e.g. a solid-state drive (SSD) within the device). In this way, the user can consume ad-supported content even when the user does not have sufficient network access. If, however, the user chooses to consume the ad-supported media content at a time when the user's device has network connectivity, then it may be advantageous to replace the set of ads that were downloaded with the media content with a new, fresher set of ads.

Accordingly, in one aspect there is provided a method for playing media content from a local storage of a player device according to an embodiment. The process includes storing the media content on the local storage unit of the player device. The process also includes, after storing the media content, detecting a request to play the media content (e.g., detecting that user has activated play button or receiving a request for a manifest for the media content). The process also includes, after detecting the request to play the media content: performing a process for obtaining from a remote server a set of ad URLs and initiating playing the media content from the local storage unit (e.g., in one embodiment initiating playing the media content consists or comprises playing the first segment of the media content; in another embodiment initiating playing the media content consists or comprises providing the requested manifest to the platform player).

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they enable a user to consume offline ad-supported media content and they enable that the user can be shown a fresher set of ads.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a message flow diagram according to an embodiment.

FIG. 3 is a message flow diagram according to an embodiment.

FIG. 4 is a message flow diagram according to an embodiment.

FIG. 5 is a message flow diagram according to an embodiment.

FIG. 6 is a message flow diagram according to an embodiment.

FIG. 7 is a flowchart illustrating a process according to an embodiment.

FIG. 8 is a block diagram an apparatus according to an embodiment.

### DETAILED DESCRIPTION

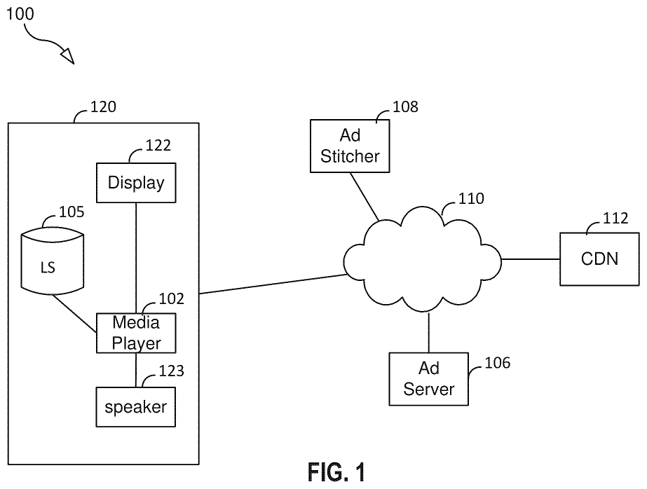

FIG. 1 illustrates a system 100 according to an embodiment. System 100 includes a user device 120 (a.k.a., player device) comprising a media player 102 (or player 102 for short), a display 122, a speaker 123, and a local storage (LS) 105 (e.g., an SSD). System 100 also includes a network 110 (e.g., the internet), an ad server 106, an ad stitcher 108, and a content data network (CDN) 112. Typically, the player 102 is a computer program that runs on processing circuitry of device 120 (e.g., mobile phone, smart TV, computer, etc.).

A user of device 120 may want to consume selected items of media content any-time, any-where, even at time when the user has limited or no network access. Accordingly, in one embodiment, the user downloads from CDN 112 the selected media content items to LS 105 (e.g., one or more episodes of a T.V. show). In one embodiment, not only is the selected media content item downloaded to LS 105, but also a set of one or more ads and a manifest for each media content item. For instance, in one embodiment, for each episode of a show that the user downloads, the device 120 also downloads a set of ads for that show (i.e. each show is associated with a set of ads). In other words, if a user downloads episode 1, the device 120 may also download a set of “ad pods” for the episode, where each ad pod is associated with a particular ad break in the episode and each ad pod consists of one or more ads to fill the ad break with which the ad pod is associated. The set of “ad pods” may include a “pre-roll” ad pod, which is an ad pod for an ad break that occurs before the episode begins. In another embodiment, device 120 downloads one set of ads for all the media content. In some embodiments, not only are one or more sets of ads downloaded, but also metadata for each ad (the metadata for an ad provides information about the ad, such as, for example, the ad's placement within the media content—e.g., in which ad break the ad should appear, expiration date, if any, and/or the date/time when the ad was downloaded).

To ensure that the user will see the freshest ads possible, in one embodiment, after (e.g., immediately after) a user indicates that the user wants to consume one of the items of media content previously downloaded to LS 105 and currently stored in LS 105, media player 102 checks whether device 120 has sufficient network access to retrieve one or more fresh ads (e.g., a fresh pre-roll ad and possibly one or more of the other non-pre-roll ads). In one embodiment, after determining that device 120 has network access, media player causes a new set of ads to be downloaded (or causes a new set of ad segment identifiers to be downloaded). In this way, during an ad break in the item of media content that the user is consuming, the user can be presented with an ad from the new set of ads. In another embodiment, after determining that device 120 has network access, player 102 first determines whether at least some of the current set of ads for the media content time are fresh (e.g., if the expiration date for the ads is far enough in the future (e.g., at least x days away), then the ads may be deemed to be fresh), and only obtains the new set of ads if the current set are not fresh. In another embodiment, rather than download a new set of ads to device 120 before the ads are requested, player 102 causes device 120 to stream the ads from CDN 112.

In another embodiment, for at least some of the ads stored in LS 105, when device 102 has network connectivity, media player occasionally (e.g., periodically) checks whether the ad is fresh and if it is not then player 102 may download from ad server 106 a fresh ad an replace the non-fresh ad with the fresh ad. For example, in some embodiments, for an item of media content that has been downloaded to LS 105, media player 102 periodically (e.g., occasionally) checks to see if the set of ads associated with the item of media content has expired, and, if so, automatically downloads a new set of ads for the item of media content (this can be done completely transparently to the user).

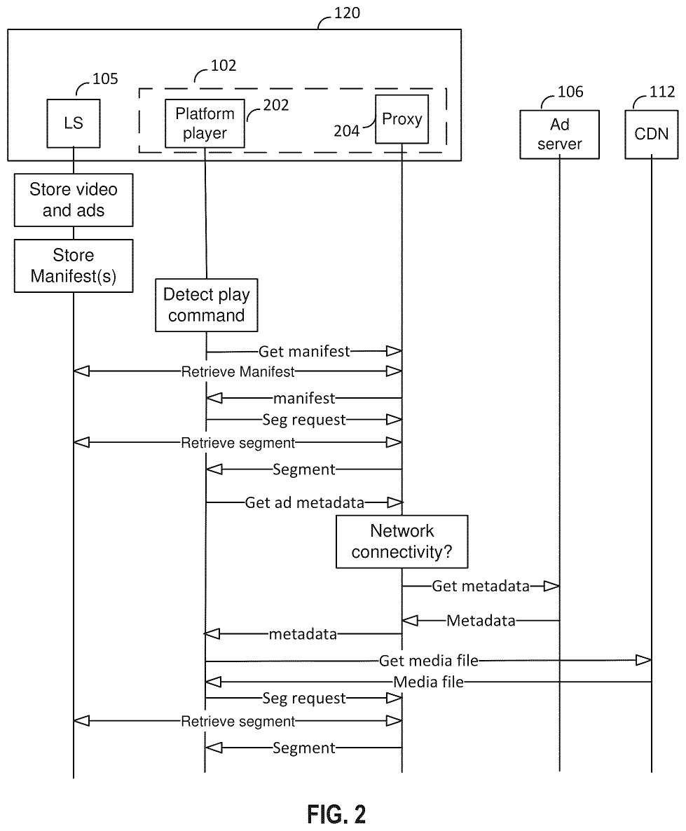

FIGS. 2-6 are message flow diagrams, each illustrating a process according to various embodiments. For sake of illustration, at least one video and a corresponding manifest for the video is stored on LS 105 (e.g., the user may have manually downloaded the video to LS 105 or device 120 may have automatically downloaded the video based on, for example, the user's preferences). Additionally, a set of ads (e.g., a set of ad pods) for the video may also be downloaded and stored on LS 105 prior to the user selecting to consume (e.g., watch) the video.

In one embodiment, the video is segmented into a plurality of segments and the manifest for the video includes a video segment identifier for each segment of the video (or template information from which each video segment's identifier can be derived). The manifest may also indicate where one or more ad breaks should occur in the video (see, e.g., Table 1A). This ad break information could also be stored in LS 105 separately from the manifest. Further, in addition to or instead of indicating where one or more ad breaks should occur in the video, the manifest also includes ad segment URLs (see, e.g., the ad segment URLs in the manifests shown in Table 1B or Table 2B).

In each of the embodiment shown in FIGS. 2-6, media player 102 is shown as comprising a platform player (PP) 202 and a proxy 204, but it is not a requirement that media player 102 be configured in this manner. For example, the function of proxy 204 may be implemented by PP 202. However, for the sake of illustration, the embodiments will be described assuming that media player 102 comprises PP 202 and proxy 204.

FIG. 2 is a message flow diagram illustrating a client-side ad insertion process according to an embodiment. As shown in FIG. 2, after the video and corresponding manifest are stored in LS 105, PP 202 detects that the user wants to consume the video (e.g., PP 202 receives a signal from an operating system of device 120 that the user has activated a “play” button to play the video). PP 202, in response to detecting that the user wants to consume the video, communicates to proxy 204 a request to trigger proxy 204 to provide to PP 202 the manifest for the video (or a modified version of the manifest for the video). In the embodiment shown, proxy 204, in immediate response to receiving the request for the manifest, retrieves the manifest from LS 105 and provides to PP 202 the retrieved manifest (or a modified version thereof—e.g., if the ad segment URLs in the manifest do not point to proxy 204, proxy 204 may rewrite the ad segments URLs so that they point to proxy 204).

After PP 202 obtains the manifest, PP 202 can start requesting the segments of the video. As shown in FIG. 2, PP 202 communicates to proxy 204 a request for a segment of the video. Proxy 204, in immediate response to receiving the request for the segment, retrieves the segment from LS 105 and provides to PP 202 the retrieved segment. These steps may be repeated a number of times. In this manner, the user can watch the video even if the user is not on-line because the segments for the video are being played from LS 105.

At some point in the process, PP 202 determines that it needs to obtain metadata for one or more ads (or other break content) to fill the one or more breaks in the video (e.g., the one or more ad breaks). Accordingly, at this point, PP 202 communicates to proxy 204 a request for metadata (this request could be a conventional Video Ad Serving Template (VAST) request). In the illustrated embodiment, proxy 204, in immediate response to receiving the request for the metadata, obtains metadata and provides the obtained metadata to PP 202. The obtained ad metadata may be a conventional VAST response (e.g., an XML file containing, among other things, one or more media file identifiers (e.g., one or more Uniform Resource Locators each pointing to a different media file for an ad)).

More specifically, in the embodiment shown, proxy 204, in immediate response to receiving the request for the metadata, determines whether or not device 120 has network connectivity. If device 120 has network connectivity, proxy 204 obtains the metadata (e.g., VAST response) from ad server 106, otherwise proxy 204 obtains the metadata from LS 105. Proxy 204 can obtain the metadata from ad server 106 by sending to ad server 106 via network 110 a request for metadata (this request may be a conventional VAST request). In one embodiment, the metadata is a VAST response that includes at least a first pointer (e.g., URL) to a first ad creative, such as a media file (e.g., MP4 file). The VAST response may also include any number of pointers to ad creatives.

In another embodiment, however, prior to receiving the request for the metadata but after detecting the user wants to watch the video (e.g., immediately in response to receiving the request for the manifest), proxy 204 determines whether or not device 120 has network connectivity. If device 120 has network connectivity, proxy 204 obtains metadata from ad server 106 and stores it in LS 105. In this embodiment, when proxy 204 receives the request for the metadata, proxy 204 retrieves the metadata it stored in LS 105 and provides this metadata to PP 202. For example, in one embodiment, assuming device 120 has network connectivity, after receiving the request for the manifest or otherwise detecting that the user has requested to watch the video, but before providing the manifest to PP 202, proxy 204 obtains the metadata from ad server 106, downloads to LS 105 one or more ad pods identified in the metadata, such as, for example, a pre-roll ad pod and/or other ad pods, stores the metadata (or modified version of the metadata) in LS 105, and then provides the requested manifest to PP 202. In this way, fresh ad pods can be downloaded and stored in device 120 before initiating the playback of the video that the user wants to watch.

After (e.g., immediately after) receiving the metadata from proxy 204, which in this example comprises information (e.g., URL) identifying at least a first media file, PP 202 uses the information identifying the first media file to retrieve the first media file (e.g., the media file may be retrieved from LS 105 if proxy downloaded the media file to LS 105 as described above or may be retrieved from CDN 112). In this example, device 120 has network connectivity and the first media file identified in the metadata is not stored in LS 105, but rather stored at CDN 112. Hence, in this example, PP 202 uses the information identifying the first media file to retrieve the first media file from CDN 112. If, however, device 120 does not have network connectivity, then the first media file identified in the metadata would be stored in LS 105. Hence, in such a scenario PP 202 uses the information identifying the first media file to retrieve the first media file from LS 105 (e.g., PP 202 may communicate to proxy 204 a request for the first media file and proxy 204 retrieves the requested media file from LS 105 and provides the retrieved media file to PP 202).

As shown in FIG. 2, PP 202 can retrieve the first media file from CDN 112 by sending to CDN 112 via network 110 a request (e.g. Hypertext Transfer Protocol (HTTP) GET request) for the identified first media file (or multiple request for different portions of the media file), and CDN 112 responds to the request by transmitting to PP 202 the request media file (or requested portion thereof).

After retrieving the requested media file (or portion thereof), PP 202 plays the media file (or portion thereof), which in this example is a video advertisement (e.g., it may play the media file in the well-known progressive download fashion). After playing the media file, PP 202 may play the remaining segments of the video. Additionally, after playing a number of segments of the video, a second ad break may be reached. In some embodiments, the metadata that was previously obtained includes information for identifying the one or more media files to be played during the second ad break. But if this is not the case, then media player 102 may obtain metadata for the second ad break (e.g., metadata that only for the second ad break) using the same process described above (i.e., the metadata for the second ad break is either obtained from ad server 106 (assuming network connectivity) or obtained from LS 105 (assuming no network connectivity)).

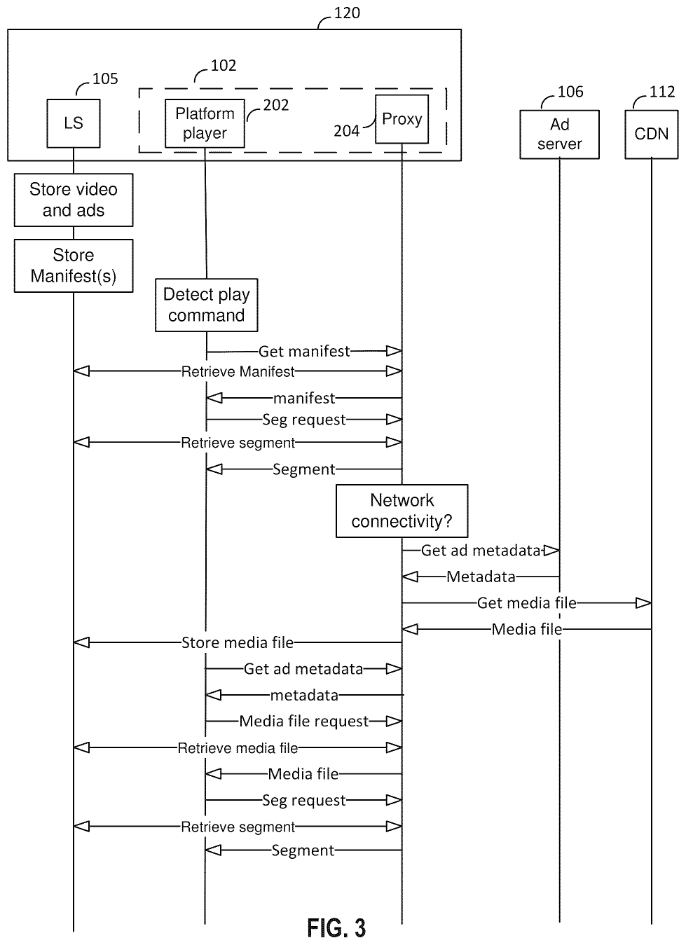

FIG. 3 is a message flow diagram illustrating a client-side ad insertion process according to another embodiment. As shown in FIG. 3, after the video and corresponding manifest are stored in LS 105, PP 202 detects that the user wants to consume the video. PP 202, in response to detecting that the user wants to consume the video, communicates to proxy 204 a request to trigger proxy 204 to provide to PP 202 the manifest for the video (or a modified version of the manifest for the video). In the embodiment shown, proxy 204, in immediate response to receiving the request for the manifest, retrieves the manifest from LS 105 and provides to PP 202 the retrieved manifest (or a modified version thereof).

After PP 202 obtains the manifest, PP 202 can start requesting the segments of the video. As shown in FIG. 3, PP 202 communicates to proxy 204 a request for a segment of the video. Proxy 204, in immediate response to receiving the request for the segment, retrieves the segment from LS 105 and provides to PP 202 the retrieved segment. These steps may be repeated a number of times.

As described above with respect to the message flow in FIG. 2, at some point in the process (which may be immediately in response to proxy 204 detecting that the user wants to play the video, for example, immediately in response to proxy 204 receiving the manifest request), proxy 204 attempts to obtain from ad server 106 metadata for one or more ads (or other break content) to fill the one or more breaks in the video (e.g., the one or more ad breaks). Accordingly, at this point, in the embodiment shown, proxy 204 determines whether or not device 120 has network connectivity. If device 120 has network connectivity, proxy 204 obtains the metadata from ad server 106. Proxy 204 can obtain the metadata from ad server 106 by sending to ad server 106 via network 110 a request for metadata (this request may be a conventional VAST request). For example, if the manifest indicates that there should be a pre-roll ad break, proxy 204 may, in response to receiving the manifest request, obtain metadata from ad server 106 where the obtained metadata identifies at least a media file for an ad that can be used as the pre-roll add. The obtained metadata may further identify one or more other media files for ads that can be used during subsequent ad breaks in the media content.

After receiving from ad server 106 the metadata, which in this example comprises information (e.g., URL(s)) identifying at least a first media file, proxy 204 uses the information identifying the first media file to retrieve the first media file from CDN 112 (if other media files are identified, those other media files may be downloaded at the same time or may be downloaded later). In this example, device 120 has network connectivity. Hence, in this example, proxy 204 uses the information identifying the first media file to retrieve the first media file from CDN 112 (if the metadata identifies multiple media files, then proxy 204 may retrieve all of the media files from CDN 112 at the same time or may download some at a later time). After obtaining the media file(s) from CDN 112, proxy 204 stores the media file(s) in LS 105.

At some point after proxy 204 stores the media file(s) in LS 105, PP 202 communicates to proxy 204 a request for metadata (this request could be a conventional VAST request). In response to receiving the request for the metadata, proxy 204 provides metadata to PP 202. In one embodiment, the metadata provided to PP 202 includes URL(s) identifying the media file(s) that proxy 204 obtained from CDN 112, however, the URLs in the metadata provided to PP 202 “point” to the media files on LS 112 not the media file at CDN 112. As an example, in the metadata obtained from ad server 106, the URL for the first media file may be of the form: http://cdn.com/mediafile1, whereas, in the metadata provided to PP 202, the URL for the first media file may be of the form: http://proxy.device.com/mediafile1 or file://media/mediafile1. In another embodiment, assuming proxy 204 has determined device 102 has network connectivity, rather than provide to PP 202 the metadata that includes the URL(s) identifying the media file(s) that proxy 204 obtained from CDN 112 in response to receiving the metadata request from PP 202 and stored in LS 105, proxy 204 may obtain new metadata from ad server 206 and then provide to PP 202 this new metadata. In one embodiment, the new metadata includes a least one URL identifying a media file and PP 202 uses the URL to obtain the media file identified by the URL (e.g., the media file may be obtained from CDN 112).

In the example shown in FIG. 3, the URL is of the form http://proxy.device.com/mediafile1. Accordingly, when PP 202 needs to play the first media file, PP 202 sends to proxy 204 a request for the media file (i.e., a request for the file named “mediafile1”). In response to this request, proxy 204 retrieves the requested media file from LS 105 and provides the retrieved media file to PP 202, which can then play the media file, which in this example is a video advertisement.

After playing the media file, PP 202 may play the remaining segments of the video. Additionally, after playing a number of segments of the video, a second ad break may be reached. In some embodiments, the metadata that was previously obtained includes information for identifying the one or more media files to be played during the second ad break. But if this is not the case, then media player 102 may obtain metadata for the second ad break using the same process described above (i.e., the metadata for the second ad break is either obtained from ad server 106 (assuming network connectivity) or obtained from LS 105 (assuming no network connectivity)).

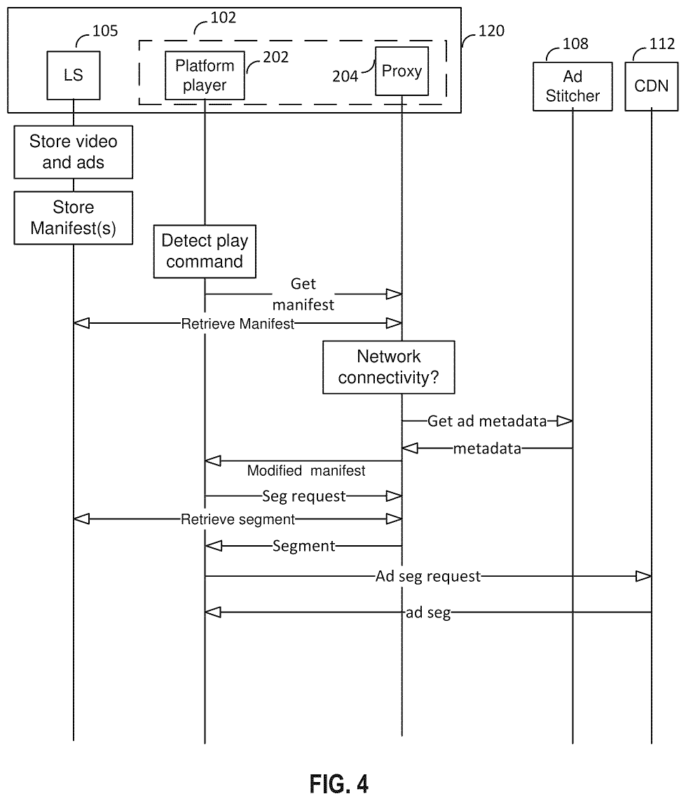

FIG. 4 is a message flow diagram illustrating a server-side ad insertion process according to an embodiment. As shown in FIG. 4, after the video and corresponding manifest are stored in LS 105, PP 202 detects that the user wants to consume the video. PP 202, in response to detecting that the user wants to consume the video, communicates to proxy 204 a request to trigger proxy 204 to provide to PP 202 the manifest for the video (or a modified version of the manifest for the video). Proxy 204, in response to receiving the request for the manifest, retrieves the manifest from LS 105 and attempts to obtain from ad stitcher 108 metadata (e.g., one or more manifests) for one or more ads (or other break content) to fill the one or more breaks in the video (e.g., the one or more ad breaks).

Accordingly, at this point, in the embodiment shown, proxy 204 determines whether or not device 120 has network connectivity. If device 120 has network connectivity, proxy 204 obtains the metadata for an ad set for one or more ad breaks from ad stitcher 108. Proxy 204 can obtain the metadata from ad stitcher 108 by sending to ad stitcher 108 a request message identifying, for at least one ad break (e.g., a pre-roll ad break), the duration of the ad break (e.g., 30 seconds) and requesting an ad set (a.k.a., ad pod) for the ad break (the request message may identify an ad break duration for each ad break individually). Ad stitcher 108 responds to the request message by transmitting to proxy 204 a response message that comprises metadata that identifies one or more ads for each ad break, and, for each identified ad, the metadata may include a set of ad segment URLs for the ad. For example, the metadata may indicate that a single 15 second ad was selected for a first ad break and may contain 3 ad segment URLs for this 15 second ad (e.g., adserver.com/ad-seg1.ts, adserver.com/ad-seg2.ts, adserver.com/ad-seg3.ts).

After receiving the metadata from ad stitcher 108, proxy modifies the manifest it retrieved from LS 105 (hereafter “original manifest”) based on the metadata received from ad stitcher 108 to produce a modified manifest. More specifically, the modified manifest may include the video segment identifiers included in the original manifest and the ad segment URLs included in the metadata. For instance, the original manifest may be the manifest shown in Table 1A or 2A and the modified manifest may be of the manifest shown in Table 1B or 2B.

After producing the modified manifest, proxy 204 provides the modified manifest to PP 202. After PP 202 obtains the modified manifest, PP 202 can start requesting the segments of the video as well as the ad segments.

As shown in FIG. 4, PP 202 communicates to proxy 204 a request for a segment of the video. Proxy 204, in immediate response to receiving the request for the segment, retrieves the segment from LS 105 and provides to PP 202 the retrieved segment. These steps may be repeated a number of times. In this manner, the user can watch the video even if the user is not on-line because the segments for the video are being played from LS 105. Additionally, if the user is on-line, PP 202 can use the ad segment URLs included in the modified manifest to retrieve the ad segments from CDN 112.

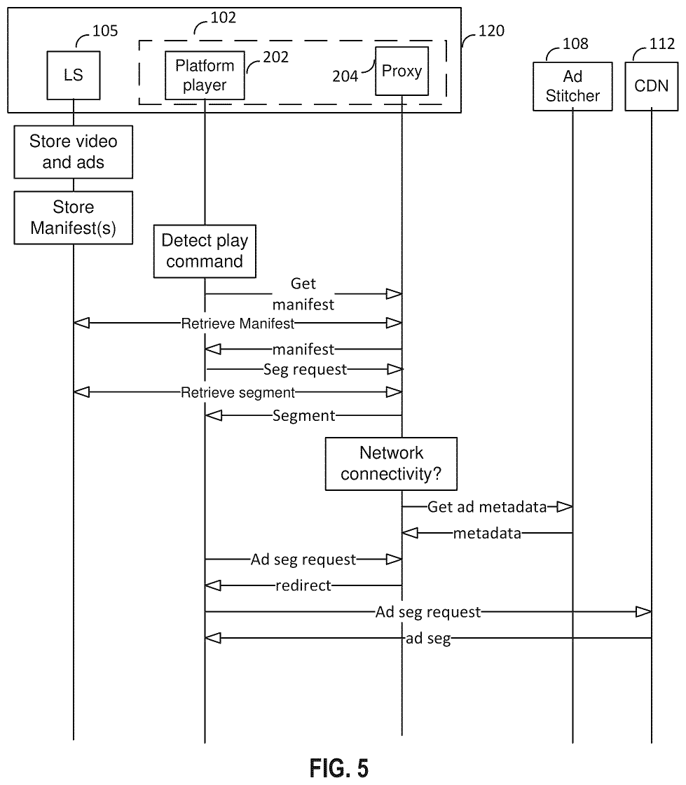

FIG. 5 is a message flow diagram illustrating a server-side ad insertion process according to another embodiment. As shown in FIG. 5, after the video and corresponding manifest are stored in LS 105, PP 202 detects that the user wants to consume the video. PP 202, in response to detecting that the user wants to consume the video, communicates to proxy 204 a request to trigger proxy 204 to provide to PP 202 the manifest for the video (or a modified version of the manifest for the video). Proxy 204, in immediate response to receiving the request for the manifest, retrieves the manifest from LS 105 and provides to PP 202 the retrieved manifest (or a modified version thereof—e.g., if the ad segment URLs in the manifest do not point to proxy 204, proxy 204 may rewrite the ad segments URLs so that they point to proxy 204)).

After PP 202 obtains the manifest, PP 202 can start requesting the segments of the video. As shown in FIG. 5, PP 202 communicates to proxy 204 a request for a segment of the video. Proxy 204, in immediate response to receiving the request for the segment, retrieves the segment from LS 105 and provides to PP 202 the retrieved segment. These steps may be repeated a number of times. In this manner, the user can watch the video even if the user is not on-line because the segments for the video are being played from LS 105.

At some point in the process (which may be immediately in response to proxy 204 receiving the manifest request or otherwise detecting that the user wants to watch the video), proxy 204 attempts to obtain from ad stitcher 108 metadata (e.g., a manifest) for one or more ads, such as a pre-roll ad and possibly other ads (or other break content) to fill the one or more breaks in the video (e.g., the one or more ad breaks). Accordingly, at this point, in the embodiment shown, proxy 204 determines whether or not device 120 has network connectivity. If device 120 has network connectivity, proxy 204 obtains the metadata from ad stitcher 108.

Proxy 204 can obtain the metadata from ad stitcher 108 by sending to ad stitcher 108 a request message identifying, for at least one ad break, an ad break duration (e.g., 30 seconds) and requesting an ad set for the ad break(s) (the request message may identify an ad break duration for each ad break individually). Ad stitcher 108 responds to the request message by transmitting to proxy 204 a response message that comprises metadata that identifies one or more ads for each ad break, and, for each identified ad, the metadata may include a set of ad segment URLs for the ad. For example, the metadata may indicate that a single 15 second ad was selected for a first ad break and may contain 3 ad segment URLs for this 15 second ad (e.g., adserver.com/ad-seg1.ts, adserver.com/ad-seg2.ts, adserver.com/ad-seg3.ts).

After receiving the metadata from ad stitcher 108, stores the ad segment URLs in memory or LS 105. In one embodiment, each ad segment URL included in the manifest provided to PP 202 is mapped to one of the ad segment URLs included in the metadata received from ad stitcher 108.

As shown in FIG. 5, at some point during play of the video, PP 202 communicates to proxy 204 a request for one of the ad segments, which request includes a segment identifier (e.g., ad-seg1.ts). In response to receiving this request for the ad segment, proxy 204 determines the ad segment URL to which the ad segment identifier is mapped. In the embodiment shown in FIG. 5, after determining the ad segment URL to which the ad segment identifier is mapped, proxy 204 communicates to PP 202 a redirect message containing the determined ad segment URL, which redirect message triggers PP 202 to send an ad segment request for the segment to CDN 112, which responds with the requested segment. After receiving the segment, PP 202 plays the segment. This process may repeat a number of times (i.e., PP 202 may request a number of ad segments to fill the current ad break).

After retrieving and playing the ad segments, PP 202 may play one or more remaining segments of the video. Additionally, after playing a number of segments of the video, a second ad break may be reached. In some embodiments, the metadata that was previously obtained includes information for identifying the one or more media files to be played during the second ad break. But if this is not the case, then media player 102 may obtain metadata for the second ad break using the same process described above (i.e., the metadata for the second ad break is obtained from ad stitcher 108 (assuming network connectivity).

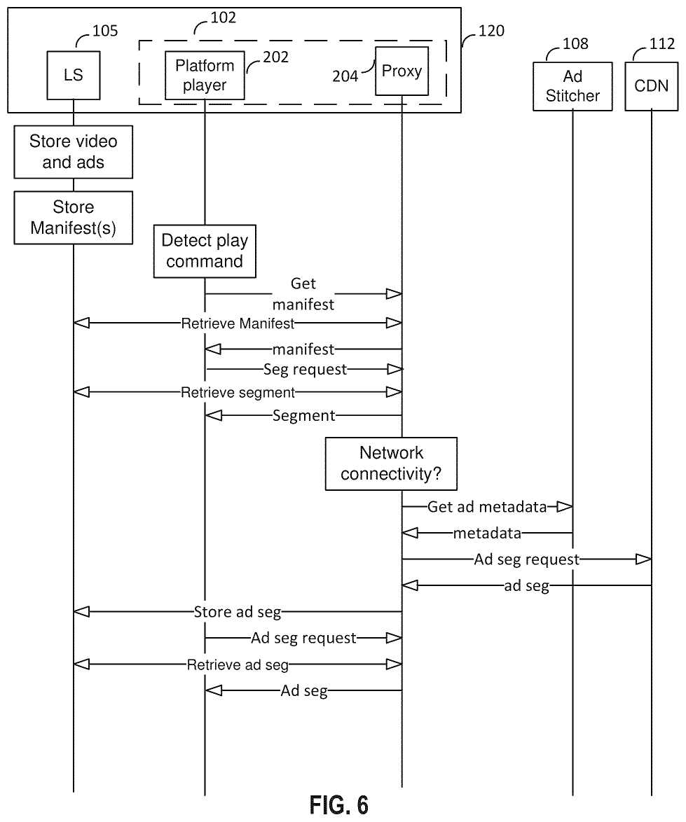

FIG. 6 is a message flow diagram illustrating a server-side ad insertion process according to another embodiment. As shown in FIG. 6, after the video and corresponding manifest are stored in LS 105, PP 202 detects that the user wants to consume the video. PP 202, in response to detecting that the user wants to consume the video, communicates to proxy 204 a request to trigger proxy 204 to provide to PP 202 the manifest for the video (or a modified version of the manifest for the video). Proxy 204, in immediate response to receiving the request for the manifest, retrieves the manifest from LS 105 and provides to PP 202 the retrieved manifest (or a modified version thereof—e.g., if the ad segment URLs in the manifest do not point to proxy 204, proxy 204 may rewrite the ad segments URLs so that they point to proxy 204)).

After PP 202 obtains the manifest, PP 202 can start requesting the segments of the video. As shown in FIG. 6, PP 202 communicates to proxy 204 a request for a segment of the video. Proxy 204, in immediate response to receiving the request for the segment, retrieves the segment from LS 105 and provides to PP 202 the retrieved segment. These steps may be repeated a number of times. In this manner, the user can watch the video even if the user is not on-line because the segments for the video are being played from LS 105.

At some point in the process (which may be immediately in response to proxy 204 detecting that the user wants to play the video, for example, immediately in response to proxy 204 receiving the manifest request), proxy 204 attempts to obtain from ad stitcher 108 metadata (e.g., a manifest) for one or more ads (or other break content) to fill the one or more breaks in the video (e.g., the one or more ad breaks such as a pre-roll ad break). Accordingly, at this point, in the embodiment shown, proxy 204 determines whether or not device 120 has network connectivity. If device 120 has network connectivity, proxy 204 obtains the metadata from ad stitcher 108.

Proxy 204 can obtain the metadata from ad stitcher 108 by sending to ad stitcher 108 a request message identifying, for at least one ad break, an ad break duration (e.g., 30 seconds) and requesting an ad pod for the ad break(s) (the request message may identify an ad break duration for each ad break individually). Ad stitcher 108 responds to the request message by transmitting to proxy 204 a response message that comprises metadata that identifies one or more ads for each ad break, and, for each identified ad, the metadata may include a set of ad segment URLs for the ad. For example, the metadata may indicate that a single 15 second ad was selected for the first ad break and may contain 3 ad segment URLs for this 15 second ad (e.g., adserver.com/ad-seg1.ts, adserver.com/ad-seg2.ts, adserver.com/ad-seg3.ts).

After receiving the metadata from ad stitcher 108, proxy 204 uses the ad segment URLs included in the metadata to retrieve from CDN 112 all of the identified ad segments and then stores these ad segments in LS 105. In one embodiment, each ad segment URL included in the manifest provided to PP 202 is mapped to one of the ad segments that proxy 204 retrieved from CDN 112 and stored in LS 105. For example, in one embodiment, each of the ad segment URLs included in the manifest provided to PP 202 points to (directly or indirectly) a segment in LS 105 and when proxy 204 stores the retrieved segments in LS it replaces each previously stored segment with a corresponding retrieved segment.

For example, if the file adX-seg1.ts is stored in LS 105 prior to proxy 204 retrieving the segments from CDN 112 and one of the of the ad segments received from CDN 112 is adY-seg1.ts, proxy 204 my delete adX-seg1.ts from LS 105 (or rename it) and then store adY-seg1.ts in LS and then rename that file to adX-seg1.ts. In this way, if the manifest that was provided to PP 202 includes a URL such as file://adX-seg1.ts, this URL will directly point to the newly downloaded ad segment (i.e., adY-seg1.ts).

As another example, if the file adX-seg1.ts is stored in LS 105 prior to proxy 204 retrieving the segments from CDN 112 and one of the of the ad segments received from CDN 112 is adY-seg1.ts, proxy 204 may simply store the file adY-seg1.ts in LS 105 and then update an internal mapping (e.g., table) to map (associate) adX-seg1.ts with asY-seg.ts. In this way, if the manifest that was provided to PP 202 includes a URL such as http://proxy.com/adX-seg1.ts, this URL will, by virtue of the internal mapping, indirectly point to the newly downloaded ad segment (i.e., adY-seg1.ts).

At some point after proxy 204 stores the ad segments in LS 105, PP 202 obtains one or more of these ad segments and plays them during the ad break with which the segments are associated.

For instance, in the embodiment shown in FIG. 6, PP 202 obtains the ad segment by communicating to proxy 204 an ad segment request containing an ad segment identifier (e.g., PP 202 communicates “GET adX-seg1.ts” to proxy 204). In one embodiment, in response, proxy 204 retrieves from LS 105 the ad segment to which the ad segment identifier included in the ad segment request (e.g., adX-seg1.ts) is mapped and provides the ad segment to PP 202. As illustrated above, this ad segment identifier adX-seg1.ts may be mapped to the ad segment in LS 105 named adY-seg1.ts or it may be mapped the ad segment in LS 105 named adX-seg1.ts. In another embodiment, assuming device 102 has network connectivity at the time proxy 204 receives from PP 202 the ad segment request, proxy 204 may respond to the ad segment request form PP 202 by providing to PP 202 a redirect message containing a pointer to a remote ad segment, such as, for example, an ad segment stored in CDN 112.

After receiving the requested segment, PP 202 plays the segment. This process may repeat a number of times (i.e., PP 202 may request a number of ad segments to fill the current ad break).

After retrieving and playing the ad segments, PP 202 may play one or more remaining segments of the video. Additionally, after playing a number of remaining segments of the video, a second ad break may be reached. In some embodiments, the metadata that was previously obtained from ad stitcher 108 includes information for identifying the one or more media files (e.g., segment files) to be played during the second ad break. But if this is not the case, then media player 102 may obtain metadata for the second ad break using the same process described above (i.e., the metadata for the second ad break is obtained from ad stitcher 108 (assuming network connectivity).

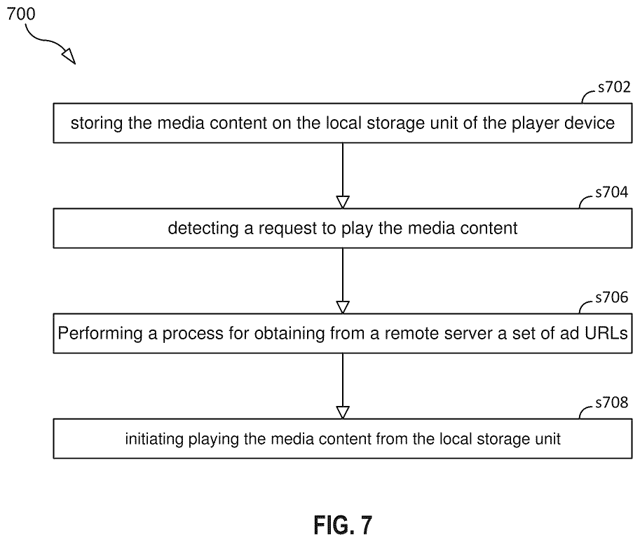

FIG. 7 is a flowchart illustrating a process 700 for playing media content from a local storage (e.g., LS 105) of a player device (e.g.,) according to an embodiment. Process 700 may begin in step s702. Step s702 comprises storing the media content on the local storage unit of the player device. Step s704 comprises, after storing the media content, detecting a request to play the media content. Process 700 further comprises, after detecting the request to play the media content: performing a process for obtaining from a remote server a set of ad URLs (step s706) and initiating playing the media content from the local storage unit (step s708).

In some embodiments, detecting the request to play the media content comprises detecting that a user has activated a play button.

In some embodiments detecting the request to play the media content consists of or comprises receiving a request for a manifest for the media content.

In some embodiments the process for obtaining the set of ad URLs comprises transmitting a request to the remote server and receiving from the remote server a response responsive to the request, the response comprises the set of ad URLs, and each ad URL identifies an ad file stored at a content server remote from the player device, and the step of initiating the playing of the media content from the local storage unit is performed after transmitting the request to the remote server.

In some embodiments the method further comprises using the set of ad URLs to retrieve the ad files.

In some embodiments the step of initiating the playing of the media content from the local storage unit is performed after using the set of ad URL to retrieve the ad files.

In some embodiments the method further comprising playing one or more of the ad files before playing any segment of the media content from the local storage unit.

In some embodiments the set of ad URLs comprises a first ad URL that identifies a first ad file, and the method further comprises, prior to playing any segment of the media content: using the first URL to download the first ad file to the local storage; and after downloading the first ad file to the local storage, playing the first ad file.

In some embodiments the set of ad URLs further comprises a second ad URL that identifies a second ad file, and the method further comprises, after playing a segment of the media content, using the second URL to download the second ad file to the local storage.

In some embodiments the set of ad URLs comprises a first ad URL that identifies a first ad file stored at a remote content server, and the method further comprises, prior to playing any segment of the media content: receiving a metadata request from a platform player (PP); and responding to the metadata request by providing to the PP metadata comprising the first ad URL, wherein the PP uses the first ad URL to obtain the first ad file from the remote content server.

In some embodiments the set of ad URLs further comprises a second ad URL that identifies a second ad file, and the method further comprises, after playing a segment of the media content: using the second URL to download the second ad file to the local storage; and after downloading the second ad file to the local storage, playing the second ad file.

In some embodiments the process for obtaining the set of ad URLs comprises: determining whether the player device has sufficient network connectivity (e.g., available bandwidth is greater than a threshold); and in response to determining that the player device has sufficient network connectivity, transmitting an ad request to the remote server.

In some embodiments the process further comprises receiving an ad response message responsive to the ad request, the ad response message comprising the set of ad URLs, and the method further comprises using the set of ad URLs to retrieve one or more media files or a plurality of media file segments.

In some embodiments each ad URL in the set of ad URLs identifies a media file segment, and the method comprises using the set of ad URLs to retrieve the media file segments.

In some embodiments each ad URL in the set of ad URLs identifies a media file containing media data for an ad.

In some embodiments the process also includes prior to detecting the request to play the media content, storing in the local storage a default set of ads, wherein the default set of ads are associated with the media content.

In some embodiments detecting the request to play the media content consists of or comprises receiving from a platform player a request for a manifest for the media content.

In some embodiments the step of performing the process for obtaining the set of ad URLs is performed in response to receiving the request for the manifest.

In some embodiments the step of performing the process for obtaining the set of ad URLs is performed in response to receiving the request for the manifest, the process for obtaining the set of ad URLs comprises transmitting a request to the remote server and receiving from the remote server a response responsive to the request, the response comprises the set of segment URLs, and each segment URL identifies a media file segment, and the method further comprises: obtaining a first manifest associated with the media content; and generating a second manifest using the first manifest and the set of segment URLs.

In some embodiments the first manifest comprises a first set of media segment identifiers, and the second manifest comprise the first set of media segment identifiers and set of segment URLs.

In some embodiments the media content comprises an ordered sequence of segments, and initiating playing the media content consists or comprises playing the first segment in the ordered sequence of segments.

In some embodiments initiating playing the media content consists or comprises providing the requested manifest to the platform player.

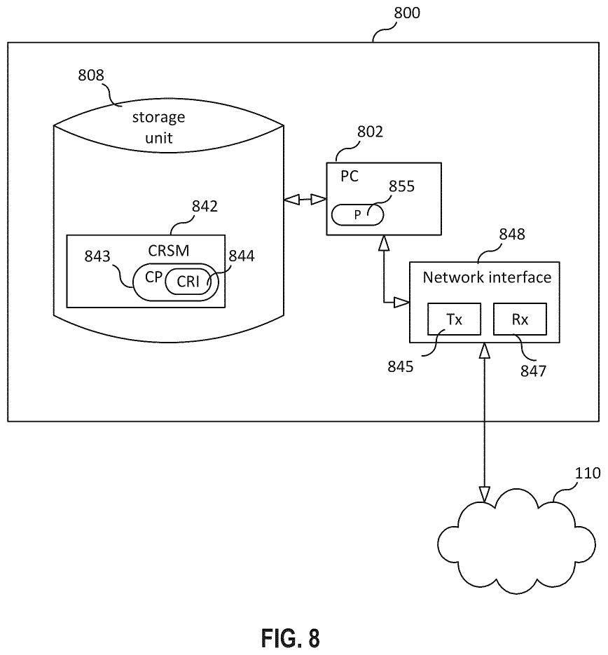

FIG. 8 is a block diagram of apparatus 800, according to some embodiments, that may implement device 120 or be a component of device 120. As shown in FIG. 8, apparatus 800 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (e.g., apparatus 800 may be a distributed computing apparatus comprising two or more computers or a single computer); at least one network interface 848 (e.g., a physical interface or air interface) comprising a transmitter (Tx) 845 and a receiver (Rx) 847 for enabling apparatus 800 to transmit data to and receive data from other network nodes connected to network 110 (e.g., an Internet Protocol (IP) network) to which network interface 848 is connected (physically or wirelessly) (e.g., network interface 848 may be coupled to an antenna arrangement comprising one or more antennas for enabling apparatus 800 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes apparatus 800 to perform steps described herein (e.g., steps described herein with reference to the flow charts). In other embodiments, apparatus 800 may be configured to perform steps described herein without the need for code. That is, for example, PC 802 may consist merely of one or more ASICs. Hence, the features of the embodiments described herein may be implemented in hardware and/or software.

### CONCLUSION

While the embodiments have been explained for video segments, the embodiments apply equally to audio segments. For example, as is known in the art, each period element of an MPD may include a video adaptation set (e.g., adaptation set with mimeType=“video/mp4”) and an audio adaptation set (e.g., adaptation set with mimeType=“audio/mp4”). Hence, the embodiments may function with content that includes only video, only audio, or both audio and video.

Also, while various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for playing media content from local storage of player device, comprising:
storing the media content on the local storage unit of the player device;
after storing the media content, detecting a request to play the media content; and
after detecting the request to play the media content:
performing a process for obtaining from a remote server a set of ad URLs, and
initiating playing the media content from the local storage unit.

2. The method of claim 1, wherein detecting the request to play the media content comprises detecting that a user has activated a play button.

3. The method of claim 1, wherein detecting the request to play the media content consists of or comprises receiving a request for a manifest for the media content.

4. The method of claim 1, wherein
the process for obtaining the set of ad URLs comprises transmitting a request to the remote server and receiving from the remote server a response responsive to the request,
the response comprises the set of ad URLs, and each ad URL identifies an ad file stored at a content server remote from the player device, and
the step of initiating the playing of the media content from the local storage unit is performed after transmitting the request to the remote server.

5. The method of claim 4, wherein
the method further comprises using the set of ad URLs to retrieve the ad files.

6. The method of claim 5, wherein
the step of initiating the playing of the media content from the local storage unit is performed after using the set of ad URL to retrieve the ad files.

7. The method of claim 4, wherein
the method further comprising playing one or more of the ad files before playing any segment of the media content from the local storage unit.

8. The method of claim 4, wherein
the set of ad URLs comprises a first ad URL that identifies a first ad file, and
the method further comprises, prior to playing any segment of the media content:
using the first URL to download the first ad file to the local storage; and
after downloading the first ad file to the local storage, playing the first ad file.

9. The method of claim 8, wherein
the set of ad URLs further comprises a second ad URL that identifies a second ad file, and
the method further comprises, after playing a segment of the media content, using the second URL to download the second ad file to the local storage.

10. The method of claim 4, wherein
the set of ad URLs comprises a first ad URL that identifies a first ad file stored at a remote content server, and
the method further comprises, prior to playing any segment of the media content:
receiving a metadata request from a platform player (PP); and
responding to the metadata request by providing to the PP metadata comprising the first ad URL, wherein the PP uses the first ad URL to obtain the first ad file from the remote content server.

11. The method of claim 10, wherein
the set of ad URLs further comprises a second ad URL that identifies a second ad file, and
the method further comprises, after playing a segment of the media content:
using the second URL to download the second ad file to the local storage; and
after downloading the second ad file to the local storage, playing the second ad file.

12. The method of claim 1, wherein the process for obtaining the set of ad URLs comprises:
determining whether the player device has sufficient network connectivity (e.g., available bandwidth is greater than a threshold); and
in response to determining that the player device has sufficient network connectivity, transmitting an ad request to the remote server.

13. The method of claim 12, wherein
the process further comprises receiving an ad response message responsive to the ad request, the ad response message comprising the set of ad URLs, and
the method further comprises using the set of ad URLs to retrieve one or more media files or a plurality of media file segments.

14. The method of claim 13, wherein
each ad URL in the set of ad URLs identifies a media file segment, and
the method comprises using the set of ad URLs to retrieve the media file segments.

15. The method of claim 13, wherein
each ad URL in the set of ad URLs identifies a media file containing media data for an ad.

16. The method of claim 1, further comprising:
prior to detecting the request to play the media content, storing in the local storage a default set of ads, wherein the default set of ads are associated with the media content.

17. The method of claim 1, wherein
detecting the request to play the media content consists of or comprises receiving from a platform player a request for a manifest for the media content.

18. The method of claim 17, wherein the step of performing the process for obtaining the set of ad URLs is performed in response to receiving the request for the manifest.

19. The method of claim 17, wherein
the step of performing the process for obtaining the set of ad URLs is performed in response to receiving the request for the manifest,
the process for obtaining the set of ad URLs comprises transmitting a request to the remote server and receiving from the remote server a response responsive to the request,
the response comprises the set of segment URLs, and each segment URL identifies a media file segment, and
the method further comprises:
obtaining a first manifest associated with the media content; and
generating a second manifest using the first manifest and the set of segment URLs.

20. The method of claim 19, wherein
the first manifest comprises a first set of media segment identifiers, and
the second manifest comprise the first set of media segment identifiers and set of segment URLs.

21. The method of claim 17, wherein
initiating playing the media content consists or comprises providing the requested manifest to the platform player.

22. The method of claim 1, wherein
the media content comprises an ordered sequence of segments, and
initiating playing the media content consists or comprises playing the first segment in the ordered sequence of segments.
